(19) United States
(12) Patent Application Publication
(10) Pub. No.: US 2024/0118031 A1
(43) Pub. Date: Apr. 11, 2024

(54) FEED TROUGH, METHOD OF FEED TROUGH FABRICATION, AND FEEDER AND SYSTEM INCLUDING FEED TROUGH

(71) Applicant: General Kinematics Corporation, Crystal Lake, IL (US)

(72) Inventors: Ben Belton, Crystal Lake, IL (US); Eric Dickinson, Crystal Lake, IL (US)

(21) Appl. No.: 18/482,676

(22) Filed: Oct. 6, 2023

Related U.S. Application Data
(60) Provisional application No. 63/378,755, filed on Oct. 7, 2022.
(60) Provisional application No. 63/384,747, filed on Nov. 22, 2022.

(51) Int. Cl. F27D 3/00

(52) U.S. Cl. CPC F27D 3/0025; F27D 11/08

(57) ABSTRACT

A feed trough for an electric arc furnace includes first and second arcuate plates, each arcuate plate having opposing first and second end edges and opposing first and second side edges. The first and second end edges include an arcuate contour, and the first and second end edges of the first and second arcuate plates are attached and first and second side edges of the first and second arcuate plates are attached. A channel is disposed between the first and second end edges, first and second side edges, and inner surfaces of the first and second arcuate plates, The channel includes at least one serpentine flow path and at least one perimeter flow path, the at least one serpentine flow path is disposed toward a midline of the feed trough and the at least one perimeter flow path is disposed outwardly of the at least one serpentine flow path.

### CROSS-REFERENCE TO RELATED APPLICATIONS

This patent claims the benefit of U.S. Provisional Patent App. No. 63/378,755, filed Oct. 7, 2022, and U.S. Provisional Patent App. No. 63/384,747, filed Nov. 22, 2022, both of which are expressly incorporated herein by reference in their entirety.

### BACKGROUND

This patent is directed to a feed trough, such as is used in combination with a feeder for a furnace, such as an electric arc furnace, and to a method of fabricating the feed trough. The patent is also directed to a feeder with the feed trough attached, a furnace system including the feed trough and the furnace, and a charging system including the feeder with the feed trough attached and the furnace, such as an electric arc furnace. The patent is further directed to methods of fabricating and operating such feeders, furnace systems, and charging systems.

Furnaces, such as electric arc furnaces, require raw material to be introduced into the furnace from time to time, or even continuously. To this end, a feeder or feed device may be provided at an inlet to the furnace by which the raw material is introduced into the furnace. For example, an electric arc furnace may be fed scrap material via a feeder through an opening in the top or the side of the furnace.

So that the entire feeder is not exposed to the high temperatures at the opening of the furnace, the feeder may have a feed trough at an outlet of the feeder via which material is introduced into the inlet of the furnace. The raw material moves across an upper surface of the trough and into the furnace. The feed trough may include a jacket through which fluid passes to cool the trough. In particular, a water jacket may include a first plate (i.e., the plate with the upper surface across which the raw material moves) and a second plate attached below and to the first plate to provide a channel therebetween.

FIG. 1 illustrates a conventionally fabricated feed trough. The trough includes a first, upper plate with an upper surface across which the raw material moves. The trough also includes a second, lower plate that is attached at corresponding side edges and end edges to the first, upper plate to define a channel therebetween. While the upper and lower plates are each curved in cross section, the pieces attaching the upper and lower plates are planar (or flat). As such, the junctions between the upper and lower plates and the attachment pieces define sharp corners, approximating a 90 degree angle in many cases.

These sharp corners result in inefficient or limited heat transfer with the fluid moving through the jacket (i.e., in the channel between the upper and lower plates). In particular, the sharp corners can create localized regions where the heat transfer between the plates and the fluid is inadequate, or less adequate. These localized regions can see an increase in heat-related fatigue relative to the remainder of the feed trough, and ultimately create the need for repair or replacement of the feed trough. While the feed trough may require replacement over time as a matter of course because of hostile environmental conditions, the additional heat-related fatigue negatively affects the rate at which repair or replacement of the feed trough is required.

Repair or replacement of the feed trough creates costs for the furnace operator in terms of labor and parts. In addition, whether repair or replacement is required, the time required to perform the repair or replacement of the feed trough affects the operation of the furnace, because the furnace cannot operate if the raw material cannot be supplied to the furnace. This can create additional costs to the furnace operator, over and above the costs for the labor and parts required to perform the repair or replacement.

It would be advantageous to overcome or substantially ameliorate one or more of the disadvantages of existing feed troughs, or at least to provide a useful alternative or improvement.

### SUMMARY

According to an aspect of the present disclosure, a feed trough for an electric arc furnace includes a first arcuate plate and a second arcuate plate, each arcuate plate having opposing first and second end edges and opposing first and second side edges. The first and second end edges include an arcuate contour and a junction between the first end edge and each of the first and second side edges include an arcuate contour. The trough also includes at least one first spacer attached to the first end edge of the first plate and the first end edge of the second plate, the first spacer having an arcuate cross-section and an arcuate contour. In addition, the trough includes at least one second spacer attached to the junction between the first side edge and the first end edge of the first plate and the junction between the first side edge and the first end edge of the second plate, and at least one third spacer attached to the junction between the second side edge and the first end edge of the first plate and the junction between the second side edge and the first end edge of the second plate. The second spacer and the third spacer each have an arcuate cross-section and an arcuate contour. Further, the trough also includes at least one fourth spacer attached to the first side edge of the first plate to the first side edge of the second plate, and at least one fifth spacer attached to the second side edge of the first plate and the second side edge of the second plate. The fourth spacer and the fifth spacer have an arcuate cross-section.

According to another aspect of the present disclosure, a feed trough for an electric arc furnace includes a first arcuate plate and a second arcuate plate, each arcuate plate having opposing first and second end edges and opposing first and second side edges. The first and second end edges include an arcuate contour, and the first and second end edges of the first and second arcuate plates are attached and first and second side edges of the first and second arcuate plates are attached. A channel is disposed between the first and second end edges, first and second side edges, and inner surfaces of the first and second arcuate plates, The channel includes at least one serpentine flow path and at least one perimeter flow path, the at least one serpentine flow path is disposed toward a midline of the feed trough and the at least one perimeter flow path is disposed outwardly of the at least one serpentine flow path.

According to yet another aspect of the present disclosure, a vibratory feeder assembly includes a vibratory feeder having a first end and a second end, and a feed trough according to either of the above aspects of the present disclosure attached to the second end of the vibratory feeder.

According to a further aspect of the present disclosure, a furnace system includes an electric arc furnace having a charging inlet, and a feed trough according to either of the above aspects of the present disclosure disposed at the charging inlet with the first end edge of the first plate proximate to the charging inlet.

According to a still further aspect of the present disclosure, a furnace charging system includes an electric arc furnace having a charging inlet, a vibratory apparatus having an outlet disposed proximate to the charging inlet of the electric arc furnace, and a feed trough according to either of the above aspects of the present disclosure attached to the outlet of the vibratory apparatus and disposed between the outlet of the vibratory apparatus and the charging inlet of the electric arc furnace.

### BRIEF DESCRIPTION OF DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIG. 1 is a fragmentary, perspective view of a conventional feed trough;

FIG. 2 is a fragmentary, side view of an embodiment of a system incorporating a vibratory apparatus with a feed trough according to the present disclosure;

FIG. 3 is a perspective view of a feed trough according to an embodiment of the present disclosure;

FIG. 4 is a fragmentary, enlarged, perspective view of the embodiment of the feed trough;

FIG. 5 is an end view of the embodiment of the feed trough;

FIG. 6 is a fragmentary, cross-sectional view of the embodiment of the feed trough taken about line 6-6 in FIG. 5;

FIG. 7 is a plan view of the embodiment of the feed trough with a series of baffles defining at least one serpentine fluid flow path shown in hidden line;

FIG. 8 is a side view of the embodiment of the feed trough;

FIG. 9 is a flowchart illustrating an embodiment of one method of fabricating an embodiment of the feed trough;

FIG. 10 is a perspective view of a first section of a feed trough according to a further embodiment of the present disclosure, the feed trough having a series of baffles defining at least one serpentine fluid flow path and at least one perimeter fluid flow path and an upper plate removed to better visualize the flow paths;

FIG. 11 is a perspective view of a second, mating section of the feed trough according to the embodiment of FIG. 10, also with the upper plate removed to better visualize the flow paths;

FIG. 12 is a perspective view of a first section of a feed trough according to a another embodiment of the present disclosure, the feed trough having a series of baffles defining at least one serpentine fluid flow path and at least one perimeter fluid flow path and an upper plate removed to better visualize the flow paths; and

FIG. 13 is a perspective view of a second, mating section of the feed trough according to the embodiment of FIG. 12, also with the upper plate removed to better visualize the flow paths.

### DETAILED DESCRIPTION OF VARIOUS EMBODIMENTS

FIG. 2 illustrates, in part, an embodiment of a system 100 including a furnace (as illustrated, an electric arc furnace) and a charging system for supplying the furnace with a raw material, for example scrap steel. The charging system includes a conveyor system 102 with an outlet end 104. This illustration is intended to provide context for an embodiment of a feed trough that is part of the charging system, which feed trough is fabricated using an embodiment of an improved method disclosed herein. This illustration is not intended to limit the disclosure to only such a system 100.

The system 100, of which a part is illustrated in FIG. 2, may itself be a sub-system of an extended or expanded system to recycle scrap material into billets of cast metal. According to such an expanded system, scrap material, for example scrap steel, is converted into cast metal billets, for example steel billets, through the use of an electric arc furnace.

Such an extended or expanded system may include a source of scrap material, such as in the form of one or more railroad cars loaded with scrap material, such as scrap steel, or a pile of scrap metal. The system may also include a transfer system (e.g., in the form of one or more overhead magnets, or cranes and loaders) that moves the scrap material from the source to the conveyor system 102 illustrated in part in FIG. 2. At the other end, the system may include one or more casting stations associated with the furnace. The stations may include cars that move along tracks (similar to railroad cars) that carry molten metal from the furnace to a caster that is configured to mold the liquid metal into billets. The stations may also include equipment for removing the formed billets from the molds, and for transporting the billets from the casting station.

With this by way of background, the conveyor system 102 illustrated in FIG. 2 may now be discussed. The conveyor system 102 includes at least one vibratory apparatus. As illustrated, the conveyor system 102 includes at least two vibratory apparatuses 106, 108, with the second also being referred to as a feeder 108. The conveyor system 102 may, and likely will, include additional conveyors upstream of the first (or left) conveyor 106 to move material to the part of the system 102 illustrated in FIG. 2.

The apparatuses 106, 108 of the illustrated conveyor system 102 are substantially similar in structure. The apparatuses 106, 108 each include a deck 110, 112 having a longitudinal axis from a first end 114, 116 to a second, opposite end 118, 120, and an exciter assembly, which exciter assembly 122 is illustrated for the feeder 108. The exciter assembly 122 includes at least one eccentric mass 126, 128 and at least one motor 130, 132 coupled to the at least eccentric mass 126, 128, the exciter assembly 122 coupled to the deck 112 and configured to move material along the deck 112. As illustrated, the vibratory apparatuses 106, 108 each feature a two-mass system including two motors, the aforementioned eccentric masses attached to the motor shafts.

It will be recognized that it is not required that all apparatuses have the same or similar features, and thus the apparatuses may vary from each other according to other embodiments. Nor is it a requirement that either of the apparatuses 106, 108 feature a two-mass system, or a two-mass system where the eccentric masses are attached to the motor shafts with the motors mounted on the exciter assembly (as opposed to an arrangement where the motors are disposed to the side of the apparatuses 106, 108 and are coupled to the eccentric masses mounted on the exciter assembly).

The conveyor 106 is disposed at a higher elevation than the feeder 108, such that the material that enters the conveyor 106 is moved along the conveyor 106 and exits the second end 118 into the first end 116 of the feeder 108. The material moving from the first end 116 to the second end 120 of the feeder 108 exits the feeder 108 into a furnace 140 to charge the furnace 140.

As illustrated, the conveyor system 102 charges the furnace 140. The furnace 140 may be an electric arc furnace. The furnace 140 may include a shell 142 and a roof 144, which roof 144 may be displaceable (e.g., translatable) relative to the shell 142. The furnace 140 may have an opening 146 to receive material from the feeder 108, which feeder 108 may be mounted on a moveable frame 148 to permit the feeder 108 to be moved towards and away from the furnace 140. The furnace 140 also may include one or more openings 150 to permit one or more electrodes 152 to be disposed through the roof 144 of the furnace 140.

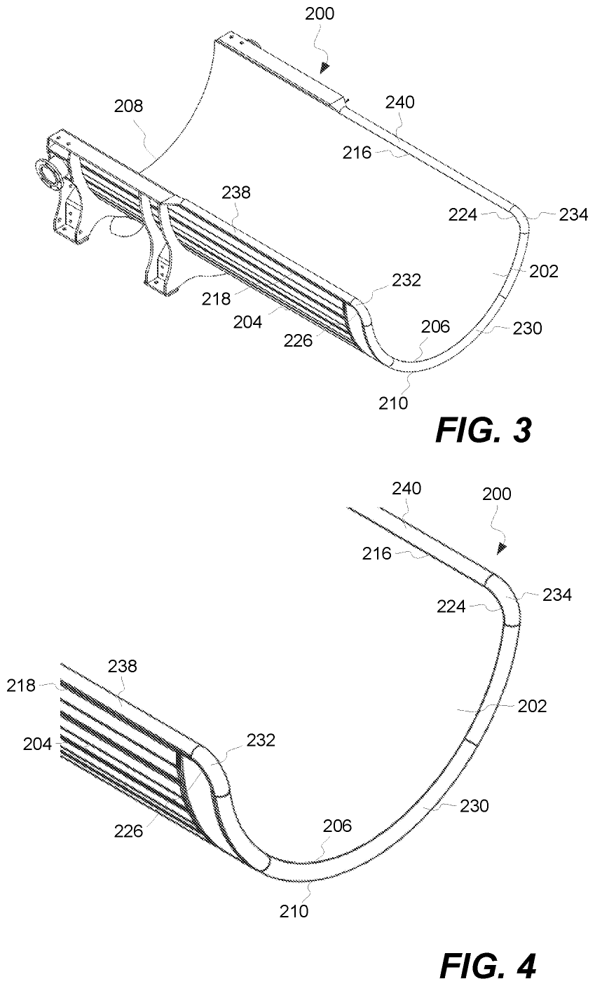

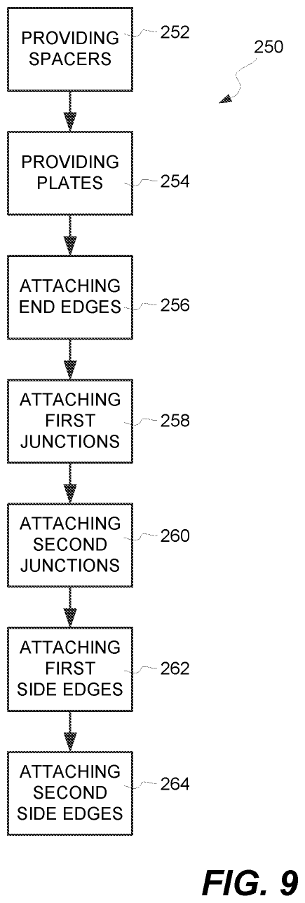

At the second end 120 of the feeder 108 is disposed the feed trough (which may also be referred to as a charging pan) 200. More particularly, the feed trough 200 is disposed at and may be attached to the second end 120 of the feeder 108, and discharges the raw material directly into the opening 146 of the furnace 140. The structure of the feed trough 200 is illustrated in FIGS. 3-6, and is fabricated according to an embodiment of the method of fabrication discussed herein and illustrated in FIG. 9.

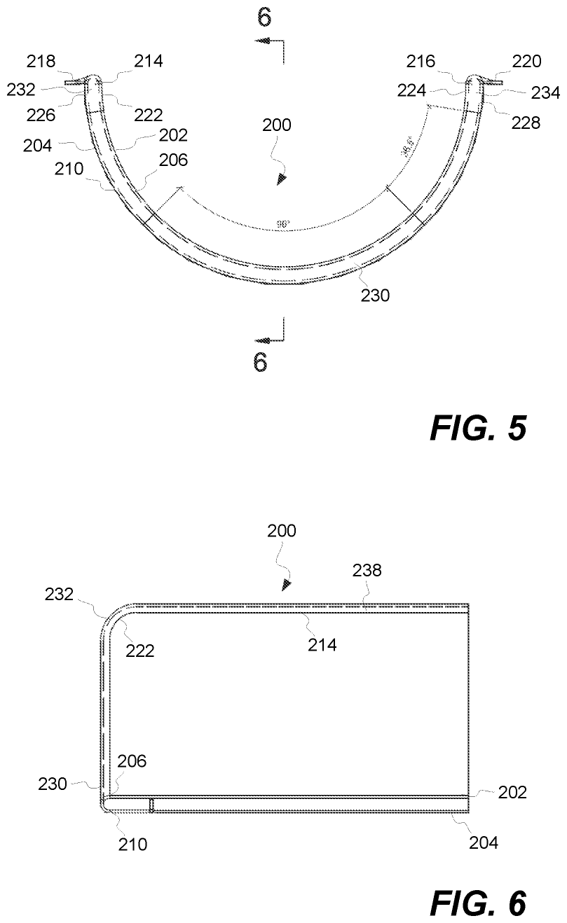

As seen in FIGS. 3-6, the feed trough 200 includes a first arcuate plate 202 and a second arcuate plate 204. Each arcuate plate 202, 204 has opposing first and second end edges 206, 208, 210, 212 (see FIGS. 3 and 8, which numbering may also be used to refer to the ends as well), and opposing first and second side edges 214, 216, 218, 220 (see FIGS. 3 and 5, which numbering may also be used to refer to the sides as well). The first and second end edges 206, 208, 210, 212 have an arcuate contour. The first and second side edges 214, 216, 218, 220 have a linear contour. A junction 222, 224, 226, 228 between the first end edge 206, 210 and each of the first and second side edges 214, 216, 218, 220 also comprises an arcuate contour (compare FIGS. 3, 5, and 6).

The first end edge 206 of the first plate 202 is attached to the first end edge 210 of the second plate 204 with at least one first spacer 230. As illustrated, the first end edge 206 of the first plate 202 is attached to the first end edge 210 of the second plate 204 with a plurality of first spacers 230. Specifically, the first end edge 206 and the first end edge 210 are attached with three spacers 230 as illustrated. Each of the first spacers 230 may be cast with an arcuate cross-section and an arcuate contour (compare FIGS. 5 and 6). Alternatively, the spacers may be fabricated by cutting a cylindrical pipe of rolled steel into two half pipes, or a half pipe may be fabricated of rolled steel, and then bent to match the arcuate contours of the plates 202, 204. As illustrated in FIG. 5, a central spacer 230 may have an arcuate contour of approximately 90 degrees, with spacers 230 disposed to either side having an arcuate contour of approximately 36.5 degrees.

The junction 222 between the first end edge 206 and the first side edge 214 of the first plate 202 is attached to the junction 226 between the first end edge 210 and the first side edge 218 of the second plate 204 with at least one second spacer 232. In a similar fashion, the junction 224 between the first end edge 206 and the second side edge 216 of the first plate 202 is attached to the junction 228 between the first end edge 210 and the second side edge 220 of the second plate 204 with at least one third spacer 234. The second spacer 232 and the third spacer 234 may each be cast with an arcuate cross-section and an arcuate contour. Alternatively, the spacers 232, 234 may be fabricated of a half pipe (such as is explained above) that is bent into an arcuate contour. These spacers 232, 234 may also be referred to as elbows.

The first side edge 214 of the first plate 202 is attached to the first side edge 218 of the second plate 204 with at least one fourth spacer 238. In addition, the second side edge 216 of the first plate 202 is attached to the second side edge 220 of the second plate 204 with at least one fifth spacer 240. The fourth spacer 238 and the fifth spacer 240 may be cast with an arcuate cross-section (see FIGS. 5 and 6). As an alternate embodiment, the fourth and fifth spacer 238, 240 may be fabricated of a half pipe (such as is explained above).

FIG. 9 illustrates an embodiment of one method 250 for fabricating the feed trough 200, the method 250 including providing the spacers 230, 232, 234, 238, 240 at a block 252. The method 250 also includes providing the first arcuate plate 202 and a second arcuate plate 204 at block 254.

The spacers 230, 232, 234, 238, 240 may be cast in shape, or alternatively the spacers 230, 232, 234, 238, 240 may be fabricated by cutting a cylindrical pipe into a two half pipe structures or rolling a half pipe with subsequent bending as necessary, as explained above. It is presently believed that casting may provide spacers with the best performance characteristics.

That is, after cutting a cylindrical pipe to form a half pipe structure, or after forming the half pipe structure from rolled steel, at least the first, second, and third spacers 230, 232, 234 must be bent to conform their contour to the contour of the curved first and second plates 202, 204 and the junctions 222, 224, 226, 228, so as to be attached to the edges of the first and second plates 202, 204. Unfortunately, this bending may create stresses in the material, which stresses might contribute to material failure. As a further issue, these bending stresses may be unpredictable within the material. As a consequence, the structure resulting from the use of bent, rolled steel might have unpredictable regions of increased stress where material failure is heightened relative to the remainder of the structure, and as such the use of cast metal (steel) spacers may provide improved performance.

The method 250 continues at block 256 with attaching the first end edge 206 of the first plate 202 to the first end edge 210 of the second plate 204 with at least the first spacer 230. At blocks 258 and 260, the method 250 continues with attaching the junction 222 between the first end edge 206 and the first side edge 214 of the first plate 202 with the junction 226 between the first end edge 210 and the first side edge 218 of the second plate 204 with at least the second spacer 232, and the junction 224 between the first end edge 206 and the second side edge 216 of the first plate 202 with the junction 228 between the first end edge 210 and the second side edge 220 of the second plate 204 with at least the third spacer 234. The method 250 further continues at block 262, with attaching the first side edge 214 of the first plate 202 to the first side edge 218 of the second plate 204 with at least the fourth spacer 238, and at block 258 with attaching the second side edge 216 of the first plate 202 to the second side edge 220 of the second plate 204 with at least the fifth spacer 240.

The attaching steps of blocks 256-264 may be performed using a joining operation, such as welding, according to the material used for the plates and spacers (e.g., steel). In such a case, the attaching each of the first, second, third, fourth, and fifth spacers 230, 232, 234, 238, 240 to the first and second plates 202, 204 may include welding each of the first, second, third, fourth, and fifth spacers 230, 232, 234, 238, 240 to the first and second plates 202, 204.

It will be recognized that the attaching steps of blocks 256-264 may be performed in a different order according to other embodiments. It is presently believed that the preferred order will be to start first with the actions of block 256, then the actions of blocks 258, 260 (in either order), and finally the actions of blocks 262, 264 (again, in either order). Alternatively, one may start at the opposite end and work toward the outlet end of the feed trough 200 (that is, the actions at blocks 262, 264 (in either order) are performed first, then the actions at blocks 258, 260 (again in either order), and finally the action at block 256). As a further alternative, one may start at one side and work around to the other side (that is, the actions would be performed in the order of block 262, 258, 256, 260, 264). As such, neither the blocks 256-264 nor the claims should be limited to a particular order of steps unless it is expressly recited that an action should be first, second, third, and so forth. Similarly, the reference to a first, second, third, etc. spacer does not require a particular order of attachment as a consequence.

It is believed that the feed trough 200 and the method 250 provide advantages over conventional feed troughs and methods for fabricating such feed troughs. In particular, it is believed that the use of the spacers with arcuate cross-section will permit the regions joining the spacers to the arcuate plates to have a smooth transition, and to avoid the sharp corners present in conventional feed troughs. It is believed that the smooth transitions will reduce, or even eliminate, the localized “hot spots” that may be caused by reduced heat transfer between the structure of the feed trough and the fluid flowing within the channel. Moreover, where the method of fabrication utilizes casting in the fabrication of the spacers, it is believed that the stresses that may otherwise be caused by the bending of the spacers into the arcuate contours required will be avoided. As this bending may not only cause these stresses in the material of the spacer, but may cause these stresses to occur in unpredictable locations, the use of cast spacers may have multiple advantages.

In addition to the feed trough 200 and its method of fabrication, it will be understood that a furnace system may include the feed trough 200 and the furnace 140. For example, a furnace system may include the electric arc furnace 140 having the charging inlet 146, and the feed trough 200 disposed at the charging inlet 146 with the first end edge 206 of the first plate 202 proximate to the charging inlet 146. A method of fabricating such a system, including disposing the feed trough 200 at the charging inlet 146, and a method of operating such a system, including moving materials across the feed trough 200 into the charging inlet 146, may also be provided.

Further, a charging system may include the feeder 108 with the feed trough 200 attached, or the feeder 108 with the feed trough 200 attached in combination with the furnace 140. For example, a charging system may include the vibratory apparatus 108 having ends 116, 120 and the feed trough 200 attached to the end 120 of the apparatus 108. Alternatively, a furnace charging system may include the electrical arc furnace 140 having the charging inlet 146, the vibratory apparatus 108 having an outlet 120 disposed proximate to the charging inlet 146 of the electric arc furnace 140, and the feed trough 200 attached to the outlet 120 of the vibratory apparatus 108 and disposed between the outlet 120 of the vibratory apparatus 108 and the charging inlet 146 of the electric arc furnace 140. A method of fabricating such a charging system or a furnace charging system, including disposing the feed trough 200 at the charging inlet 146, and a method of operating such a system, including moving a charging material (e.g., scrap metal) across the feed trough 200 into the charging inlet 146, may also be provided.

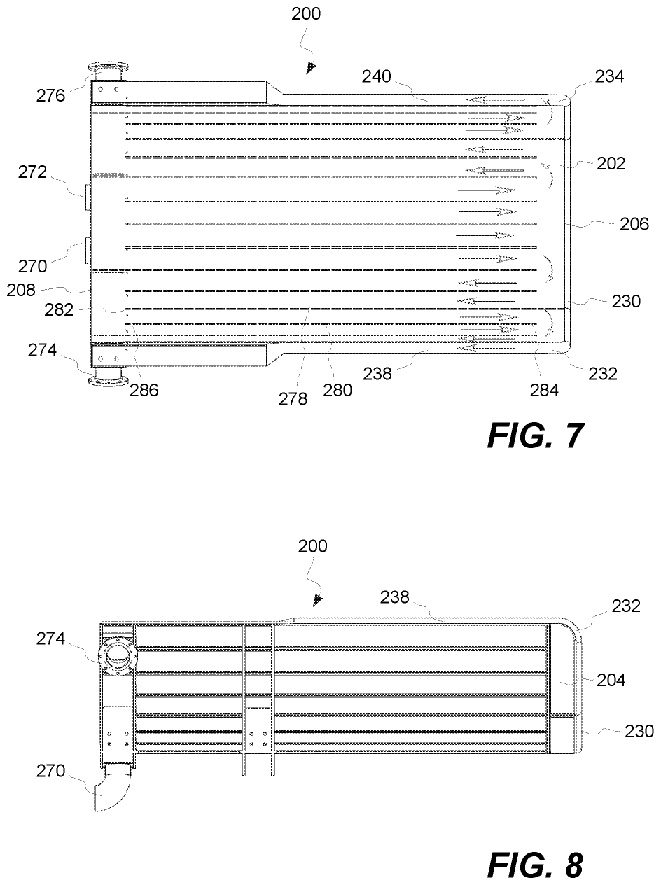

It will be recognized that the structure of the feed trough and its fabrication may include additional variations beyond that shown principally in FIGS. 3-6 and 9. For example, one such additional variation is illustrated in FIGS. 7 and 8, in that the channel defined between the plates 202, 204 by the plates 202, 204 and the spacers, 230, 232, 234, 238, 240 may include one or more baffles therein. These baffles may be used to cause the fluid passing through the channel to move along one or more paths between at least one inlet and at least one outlet; while serpentine paths are illustrated in FIGS. 7 and 8, the fluid may follow other paths instead or in addition to such serpentine paths according to other embodiments. It is believed that the movement of the fluid through such serpentine paths may further improve the heat transfer, and thus the cooling of the feed trough.

As illustrated in FIGS. 7 and 8, the trough 200 includes at least one inlet 270, 272 for fluid to enter the channel formed between the plates 202, 204. As illustrated, the trough 200 includes two inlets 270, 272, only one of which (270) is visible in FIG. 8. Additional equipment may be coupled to the inlets 270, 272 to introduce fluid into the inlets 270, 272, and through the inlets 270, 272 into the channel. For example, one or more pumps may be attached between the inlets 270, 272 and a fluid source (e.g., a fluid tank), as may filters to ensure that the fluid passed through the one or more pumps and the channel does not include contaminants.

As is also illustrated in FIGS. 7 and 8, the trough 200 includes at least one outlet 274, 276 for fluid to exit the channel formed between the plates 202, 204. As illustrated, the trough 200 also includes two outlets 274, 276, only one of which (274) is visible in FIG. 8. Additional equipment may be coupled to the outlets 274, 276 to receive the fluid passing through the channel. For example, one or more tanks may be disposed downstream of the outlets 274, 276 to receive and hold the fluid from the outlets 274, 276, which one or more tanks may include the fluid source or may be coupled to the fluid source to permit recirculation of the fluid. Again, filters and other equipment may be included to reduce or limit contaminants in the fluid.

Between the inlets 270, 272 and the outlets 274, 276 are disposed a number of baffles that define the paths between the inlets 270, 272 and the outlets 274, 276, in conjunction with the plates 202, 204 and the spacers 230, 232, 234, 238, 240. Embodiments may include at least one baffle, or may include a plurality of baffles, although the exact number of baffles disposed between the plates 202, 204 may be less than, equal to, or greater than the number of baffles illustrated in FIG. 7. The baffles may be in the form of one or more straight wall pieces as illustrated, or may be of other forms in other embodiments (e.g., wave or saw tooth pattern). Where the trough 200 is made of steel, the baffles also may be made of steel as well.

The baffles may have a height that is comparable to the spacing between the plates 202, 204. For example, the baffles may have a height that is approximately the same as the distance between inner surfaces of the plates 202, 204. The baffles may be attached to one or both of the plates 202, 204; for example, the baffles may be joined (e.g., by welding) to at least one of the plates 202, 204.

As illustrated in FIG. 7, the baffles may have a length in a longitudinal direction that is less than a distance from one end (e.g., end 208) to the other end (e.g., end 206) of the plates (e.g., plate 202). In fact, as illustrated, the baffles may be of two different lengths: a first baffle 278 having a first length and a second baffle 280 having a second length. The first baffle 278 may extend from or approximately from one of the ends of the plates 202, 204 (e.g., the end 206 or the end 208) to an end 282 spaced from the other of the ends of the plates 202, 204 (e.g., the end 208 or the end 206, respectively). The second baffle 280 may have ends 284, 286 that are spaced from each of the ends of the plates 202, 204 (i.e., the ends 206, 208).

The exact distance (or spacing) of the ends 282, 284, 286 of the baffles 278, 280 from the ends 206, 208, 210, 212 of the plates 202, 204 (and thus from the spacer(s) 230 and/or a metal plate(s) joined (e.g., by welding) at the ends 208, 212 of the plates 202, 204) may vary among the baffles 278, 280, or may be approximately the same for all baffles 278, 280. As illustrated, the length of the baffles 278 may be the same for all baffles 278, and may be approximately 90 to 95% of the distance between the ends of the plates 202, 204. As is also illustrated, the length of the baffles 280 may be the same for all baffles 280, and may be approximately 80 to 85% of the distance between the ends of the plates 202, 204.

As illustrated, the baffles 278, 280 are arranged to define two serpentine flow paths, a first path between the inlet 270 and the outlet 274 and a second path between the inlet 272 and the outlet 276. To this end, two baffles 278 are disposed outward of the inlets 270, 272, while three baffles 280 are disposed between the baffles 278, thereby defining four straight path segments from one end of the trough 200 to the other end. A second pair of baffles 278 are disposed outwardly from the first pair of baffles 278, and whereas the first pair extended from, for example, the ends 208, 212 of plates 202, 204, the second pair extend from the ends 206, 210 of the plates 202, 204. Between one of the first pair of baffles 278 and a respective one of the second pair of baffles 278 is disposed a baffle 280 to define two straight path segments in an opposite direction, relative to the longitudinal axis of the trough 200, than the previous four straight path segments. The first four straight path segments are in fluid communication with the two straight path segments to either side by a hairpin turn. This pattern is then repeated with a third pair of baffles 278 disposed outwardly from the second pair of baffles 278 and so on until the paths connect with the outlets 274, 276.

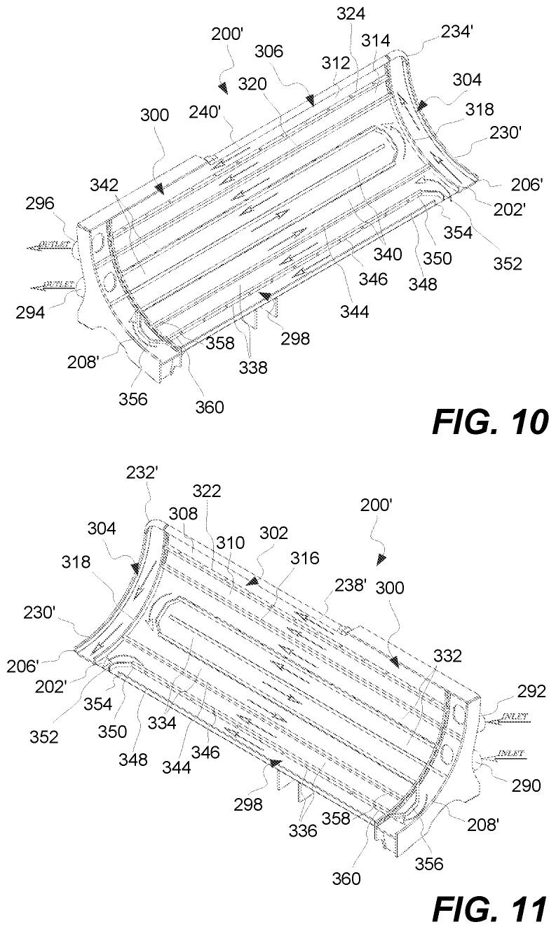

A further embodiment of a trough is illustrated in FIGS. 10 and 11 wherein the channel, defined between the plates (which may be referred to as inner and outer plates) by the plates and the spacers, includes one or more baffles therein. The feed trough is illustrated in two parts, divided along a midline of the trough, for ease of illustration, not to necessarily suggest a method of fabrication.

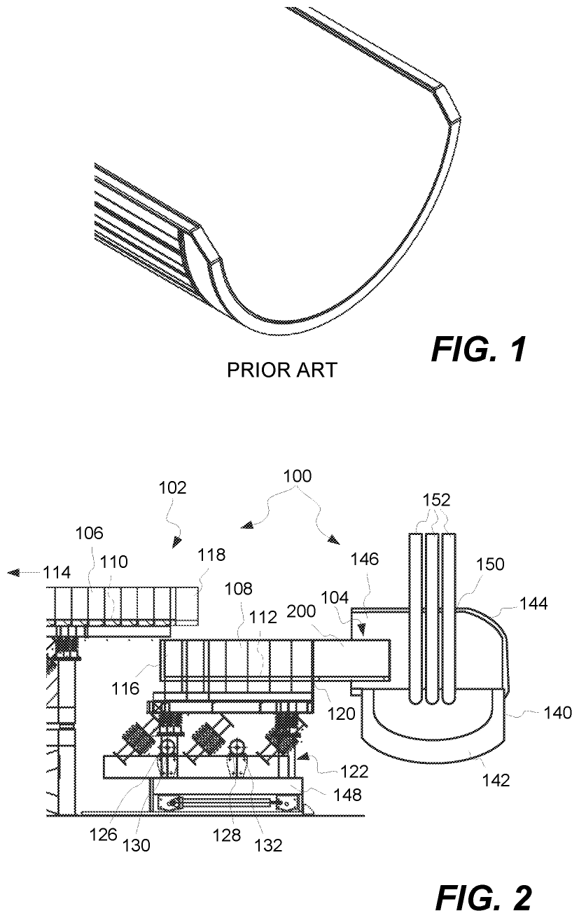

Again, the baffles may be arranged, at least in part, to cause the fluid passing through the channel to move along one or more paths between at least one inlet and at least one outlet. According to this embodiment, at least one of the fluid flow paths is a serpentine path, similar to that illustrated in FIGS. 7 and 8, with flow that passes back-and-forth between the ends of the trough. As illustrated, there are two separate serpentine flow paths between an inlet and an outlet coupled to the serpentine flow paths. Additionally, at least one of the fluid flow paths is a perimeter path, in that it extends along the edge of the trough, generally adjacent to the spacers. It is believed that the movement of the fluid through such serpentine and perimeter paths may further improve the fluid flow, and thus the heat transfer and cooling of the feed trough; as such, the paths may represent an improvement separate from the spacers that may be used with a trough as illustrated in FIG. 1 to improve such a trough.

While the trough of FIGS. 10 and 11 has baffles arranged in the channel to define at least one serpentine path and at least one perimeter path, it will be recognized that the remaining features of the trough of FIGS. 10 and 11 are similar to the features of the trough illustrated in FIGS. 2-8. Consequently, the above discussion relative to the embodiments of the trough of FIGS. 2-8 and the embodiments of the method of FIG. 9 applies to the embodiment of FIGS. 10 and 11, except as relates to the at least one serpentine flow path and at least one perimeter flow path. As a further consequence, the structures illustrated in FIGS. 10 and 11 similar to those illustrated in FIGS. 2-8 have been numbered similarly, except with the inclusion of a prime in FIGS. 10 and 11.

Turning first to FIG. 11, the trough 200′ includes at least one inlet 290, 292 for fluid to enter the channel formed between the two (inner and outer) plates, of which only the plate 202′ is illustrated so as to better visualize the flow paths. Additional equipment may be coupled to the inlets 290, 292 to introduce fluid into the inlets 290, 292, and through the inlets 290, 292 into the channel. For example, one or more pumps may be connected between the inlets 290, 292 and a fluid source (e.g., a fluid tank); filters also may be used to reduce or limit contaminants in the fluid flowing through the channel.

As is illustrated in FIG. 10, the trough 200′ also includes at least one outlet 294, 296 for fluid to exit the channel formed between the plates (again, of which only plate 202′ is illustrated). Here as well, additional equipment may be coupled to the outlets 294, 296 to receive the fluid passing through the channel. For example, one or more tanks may be disposed downstream of the outlets 294, 296 to receive and hold the fluid from the outlets 294, 296, which one or more tanks may include the fluid source mentioned above, or may be coupled to the fluid source to permit recirculation of the fluid. Again, filters and other equipment may be included to reduce or limit contaminants in the fluid.

Between the inlets 290, 292 and the outlets 294, 296 are disposed a number of baffles that define the paths between the inlets 290, 292 and the outlets 294, 296 in conjunction with the plates (e.g., 202′) and the spacers 230′, 232′, 234′, 238′, 240′. Embodiments may include at least one baffle, or may include a plurality of baffles, although the exact number of baffles disposed between the plates may be less than, equal to, or greater than the number of baffles illustrated in FIGS. 10 and 11. The baffles may be in the form of one or more straight wall pieces as illustrated, or may be of other forms in other embodiments (e.g., wave or saw tooth pattern). Where the trough 200′ is made of steel, the baffles also may be made of steel as well.

The baffles may have a height that is comparable to the spacing between the plates. For example, the baffles may have a height that is approximately the same as the distance between inner surfaces of the plates. The baffles may be attached to one or both of the plates; for example, the baffles may be joined (e.g., by welding) to at least one of the plates (e.g., plate 202′).

As stated above, the baffles are arranged to define at least one serpentine flow path 298 and at least one perimeter flow path 300. As illustrated in FIGS. 10 and 11, the serpentine flow path(s) 298 are disposed toward the center of the trough 200′ (i.e., closer to the midline of the trough 200′). The perimeter flow path(s) 300 are disposed outwardly of the serpentine paths 298, and generally adjacent the spacers 230′, 232′, 234′, 238′, 240′.

In particular, the perimeter flow paths 300 include a first leg 302 adjacent the spacer 238′, a second leg 304 adjacent the spacers 230′, 232′, 234′, and a third leg 306 adjacent the spacer 240′. The first and third legs 302, 306 include two parallel passages 308, 310 and 312, 314, while the second leg 206 includes a single passage. According to other embodiments, all three legs 302, 304, 306 may instead have a single passage or a plurality of passages. Fluid enters the perimeter flow paths 300 via the inlet 292, flows along passages 308, 310 of the first leg 302, along the second leg 304, and along passages 312, 314 of the third leg 306, and exits via the outlet 296.

Baffles 316, 318, 320 define, in part, the legs 302, 304, 306 of the perimeter flow paths 300. Baffles 322, 324 separate the passages 308, 310, 312, 314 of the first and third legs 302, 306. In addition, gated walls (i.e., walls with apertures therein) may be provided at the transitions between the first and third legs 302, 306 and the second leg 304 and adjacent the inlet 292 and outlet 296 to provide added structural support.

It will be recognized that the baffles 316, 318, 320 not only define, in part, the legs 302, 304, 306 of the perimeter flow paths 300, but they separate the serpentine flow paths 298 from the perimeter flow paths 300. In addition, the baffles 316, 318, 320 define, in part, the serpentine flow paths 298. The illustrated embodiment is but one example of the disclosed subject matter, however.

As to the serpentine flow paths 298, it will be recognized that the paths 298 are generally grouped into pairs of passages. In each instance, fluid in the adjacent passages in each pair of passages flows in a common direction, either toward the first end (i.e., the discharge end of the trough 200′) or the second end (i.e., the inlet end of the trough 200′). Moreover, fluid in adjacent pairs of passages flows in opposite directions.

Starting then with the inlet 290 in FIG. 11, a first pair of passages 332 extend from the inlet 290 in the direction of the first end of the trough 200′. The passages 332 are in fluid communication with and fluid flows into a second pair of passages 334 after a first turn. In a similar way, the second pair of passages 334 are succeeded by third, fourth, and fifth pairs of passages 336, 338, 340, each of which is in fluid communication with the preceding and succeeding pair of passages. The fifth pair of passages 340 is in fluid communication with a sixth pair of passages 342, which are in fluid communication with the outlet 294 by which fluid exits the trough 200′.

As stated above, the baffles 316, 318, 320 define not only legs (or sections) of the perimeter flow path(s) 300, but certain of the pairs of the serpentine flow path(s) 298 (e.g., 332, 342). In addition, a plurality of longitudinal baffles are disposed between and parallel to the baffles 316, 320 to define, in part, the back and forth motion of the fluid flow path between the first and second ends of the trough 200′. Because each of the pairs of passages 332, 334, 336, 338, 340, 342 flows in opposite directions, a plurality of lateral baffles are disposed adjacent either the first end or the second end of the longitudinal baffles and with the lateral baffle 318 form the turns in the serpentine flow path 298.

As illustrated in FIGS. 10 and 11, the plurality of longitudinal baffles may have different lengths in a longitudinal direction. A first subset of longitudinal baffles 344 extend from a position adjacent one end (e.g., end 208′) to the lateral baffle 318 disposed at the other end (e.g., end 206′) of the plates (e.g., plate 202′). As also illustrated, the remaining baffles may also be of a plurality of different lengths: a second subset of longitudinal baffles 346 having a length shorter than the length of the first subset, and a third subset of longitudinal baffles 348 having a length shorter than the length of the second subset. The second subset of longitudinal baffles 346 may extend to an end 350 spaced from the baffle 318 to permit flow of fluid between a first subset of lateral baffles 352 disposed at and adjoining the ends 350 and the baffle 318. The third plurality of longitudinal baffles 348 each may have an end 354 spaced from one of the first subset of lateral baffles 352 to permit flow of fluid between the lateral baffle 352 and the end 354 of the longitudinal baffle 348.

A second subset of lateral baffles 356 is disposed at ends 358, 360 of the first and second subsets 344, 346 to define the turns between adjoining passages in each pair of passages. In particular, the baffles 356 may be disposed at and adjoining the ends 360 of baffles of the second subset 346, while the ends 358 of the first subset 344 may be disposed such that fluid may flow between the ends 358 and the baffles 356. In addition, further walls and/or baffles may be disposed at the second end 208′ of the plate 202′ to cooperate with the baffles 356 to define the turns between adjoining passages in the pairs of passages. Moreover, one or more gated walls with apertures may be disposed at this end to provide structural reinforcement while permitting flow of fluid.

In operation, a fluid is circulated through the serpentine flow paths 298 and a fluid is circulated through the perimeter flow paths 300. One type of fluid (e.g. water) may be used for both flow paths, or different types of fluids may be used in the paths 298, 300. In a similar way, the same equipment may be used to move the fluid through both paths 298, 300, or different equipment (e.g., pumps, filters, tanks, and the like) may be used for the paths 298 as opposed to the paths 300. Separate equipment may allow for variations in the flow rates, for example, between the paths 298 and the paths 300.

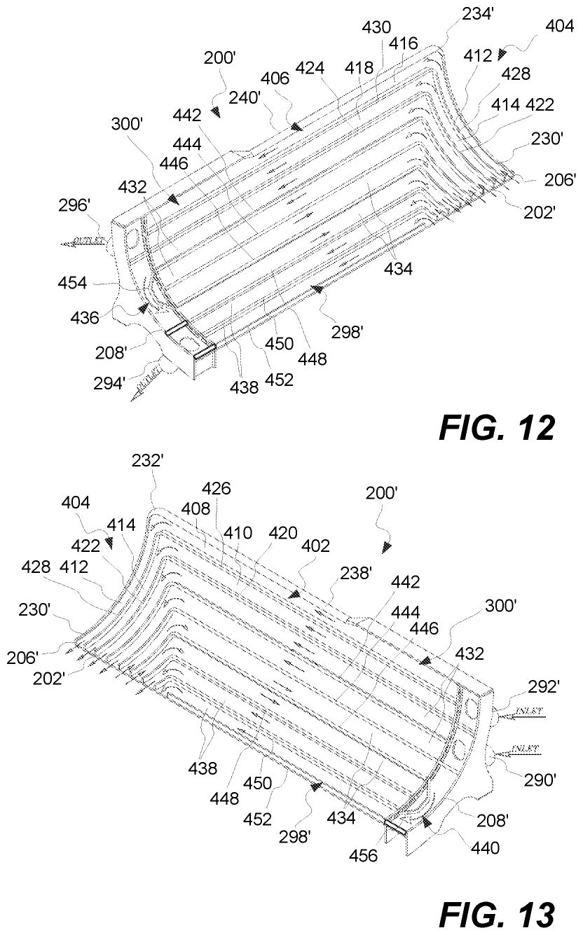

Another embodiment of a trough is illustrated in FIGS. 12 and 13 wherein the channel, defined between the (inner and outer) plates by the plates and the spacers, includes one or more baffles therein. Like the embodiment of FIGS. 10 and 11, the trough has been illustrated in two parts divided along a midline of the trough for ease of illustration, not to necessarily suggest a method of fabrication.

Similar to the embodiment of the trough in FIGS. 10 and 11, the trough of FIGS. 12 and 13 has a plurality of fluid flow paths, including at least one serpentine fluid flow path and at least one perimeter fluid flow path. The at least one serpentine fluid flow path is disposed between at least a first inlet and at least a first outlet. The at least one perimeter fluid flow path extends along the edge of the trough, generally adjacent to the spacers, and is disposed between at least a second inlet and at least a second outlet. As stated above, it is believed that the movement of the fluid through such serpentine and perimeter paths may further improve the fluid flow, and thus the heat transfer and cooling of the feed trough, and may even improve a trough such as is illustrated in FIG. 1. Moreover, it is believed that the serpentine fluid flow path of FIGS. 12 and 13 may have additional advantages over the serpentine fluid flow path of FIGS. 10 and 11.

While the trough of FIGS. 12 and 13 has baffles arranged in the channel to define at least one serpentine path and at least one perimeter path, it will be recognized that the remaining features of the trough are similar to the features of the trough illustrated in the other figures, and in particular those of FIGS. 10 and 11. Consequently, the above discussion relative to the embodiments of the trough of FIGS. 2-8 and FIGS. 10 and 11 and the embodiments of the method of FIG. 9 applies to the embodiment of FIGS. 12 and 13 in a general way. As such, the structures illustrated in FIGS. 12 and 13 similar to those illustrated in FIGS. 2-8 or FIGS. 10 and 11 have been numbered similarly, except with the inclusion of a prime in FIGS. 12 and 13.

Turning first to FIG. 13, the trough 200′ includes at least one inlet 290′, 292′ for fluid to enter the channel formed between the two (inner and outer) plates, of which only the plate 202′ is illustrated so as to better visualize the flow paths. Additional equipment may be coupled to the inlets 290′, 292′ to introduce fluid into the inlets 290′, 292′, and through the inlets 290′, 292′ into the channel. For example, one or more pumps may be connected between the inlets 290′, 292′ and a fluid source (e.g., a fluid tank); filters also may be used to reduce or limit contaminants in the fluid flowing through the channel.

As is illustrated in FIG. 12, the trough 200′ also includes at least one outlet 294′, 296′ for fluid to exit the channel formed between the plates (again, of which only plate 202′ is illustrated). Here as well, additional equipment may be coupled to the outlets 294′, 296′ to receive the fluid passing through the channel. For example, one or more tanks may be disposed downstream of the outlets 294′, 296′ to receive and hold the fluid from the outlets 294′, 296′, which one or more tanks may include the fluid source mentioned above, or may be coupled to the fluid source to permit recirculation of the fluid. Again, filters and other equipment may be included to reduce or limit contaminants in the fluid.

Between the inlets 290′, 292′ and the outlets 294′, 296′ are disposed a plurality of baffles that define the paths between the inlets 290′, 292′ and the outlets 294′, 296′ in conjunction with the inner and outer plates (e.g., 202′) and the spacers 230′, 232′, 234′, 238′, 240′. Embodiments may include at least one baffle, or may include a plurality of baffles, although the exact number of baffles disposed between the plates may be less than, equal to, or greater than the number of baffles illustrated in FIGS. 12 and 13. The baffles may be in the form of one or more straight or curved wall pieces as illustrated, or may be of other forms in other embodiments (e.g., wave or saw tooth pattern). Where the trough 200′ is made of steel, the baffles also may be made of steel as well.

The baffles may have a height that is comparable to the spacing between the plates. For example, the baffles may have a height that is approximately the same as the distance between inner surfaces of the plates. The baffles may be attached to one or both of the plates; for example, the baffles may be joined (e.g., by welding) to at least one of the plates (e.g., plate 202′).

As stated above, the baffles are arranged to define at least one serpentine flow path 298′ and at least one perimeter flow path 300′. As illustrated in FIGS. 12 and 13, the serpentine flow path(s) 298′ are disposed toward the center of the trough 200′ (i.e., closer to the midline of the trough 200′). The perimeter flow path(s) 300′ are disposed outwardly of the serpentine paths 298, and generally adjacent the spacers 230′, 232′, 234′, 238′, 240′.

In particular, the perimeter flow paths 300′ include a first leg 402 adjacent the spacer 238′, a second leg 404 adjacent the spacers 230′, 232′, 234′, and a third leg 406 adjacent the spacer 240′. All three legs 402, 404, 406 include two parallel passages 408, 410, 412, 414, 416, 418. According to other embodiments, the legs 402, 404, 406 may have different numbers of passages, or even a single passage for each leg. Fluid enters the perimeter flow paths 300′ via the inlet 292′, flows along passages 408, 410 of the first leg 402, along passages 412, 414 of the second leg 404, and along passages 416, 418 of the third leg 406, and exits via the outlet 296′.

In particular, the passage 408 may be in fluid communication with the passage 412 that is in turn in fluid communication with the passage 416. In a similar fashion, the passage 410 is in fluid communication with the passage 414 that is in fluid communication with the passage 418. Consequently, the passages 408, 412, 416 and 410, 414, 418 may be described as defining two perimeter fluid flow paths, one outer (directly adjacent the spacers 230′, 232′, 234′, 238′, 240′) and one inner (directly adjacent the outer perimeter fluid flow path). As illustrated, these perimeter fluid flow paths may be separate from each other except adjacent the inlet 292′ and the outlet 296′.

Baffles 420, 422, 424 define in part the legs 302, 304, 306 of the perimeter flow paths 300. Baffles 426, 428, 430 separate the passages 408, 410, 412, 414, 416, 418 of the legs 402, 404, 406, and thus the inner and outer perimeter fluid flow paths. As illustrated, the baffles 420, 422, 424 may be formed or joined as a single unit, with curved or rounded transitions between baffles 420, 422 and 422, 424. In a similar way, the baffles 426, 428, 430 may be formed or joined as a single unit, with curved or rounded transitions between baffles 426, 428 and 428, 430. In addition, gated walls (i.e., walls with apertures therein) may be provided adjacent the inlet 292′ and outlet 296′ to provide added structural support.

It will be recognized that the baffles 420, 422, 424 not only define, in part, the legs 402, 404, 406 of the perimeter flow paths 300′, but they separate the serpentine flow paths 298′ from the perimeter flow paths 300′. In addition, the baffles 420, 422, 424 define, in part, the serpentine flow paths 298′. The illustrated embodiment is but one example of the disclosed subject matter, however.

As to the serpentine flow paths 298′, it will be recognized that the paths 298′ are generally grouped into pairs of U-shaped passages, or loops. In each instance, fluid in the adjacent passages in each pair of passages flows longitudinally in a common first direction along a first leg, either toward the first end (i.e., the discharge end of the trough 200′) or the second end (i.e., the inlet end of the trough 200′), flows transversely in a common second direction along a second leg, and then in a common third direction along a third leg. The fluid flow direction in the third leg is opposite the fluid flow direction in the first leg. This is unlike the pairs of passages illustrated in FIGS. 10 and 11, where the fluid flow direction was generally either toward the first end or the second end.

Also unlike the serpentine fluid flow paths 298 of the embodiment illustrated in FIGS. 10 and 11, the serpentine fluid flow paths 298′ of the embodiment illustrated in FIGS. 12 and 13 are disposed in a series of concentric or nested loops, from the outermost loop that is in fluid communication with the inlet 290′ to the innermost loop that is in fluid communication with the outlet 294′. As illustrated, there are three nested loops, although according to other embodiments the number of loops may be greater or lesser than the number illustrated in FIGS. 12 and 13. By comparison, the serpentine fluid flow paths 298 of the embodiment illustrated in FIGS. 10 and 11 are disposed in a series of successive pairs of passages, in what may also be referred to as a back-and-forth pattern.

Starting then with the inlet 290′ in FIG. 13, a first (outermost) pair of U-shaped loops 432 are nested immediately adjacent (or within) the perimeter flow paths 300′, separated from the perimeter flow paths 300′ by the baffles 420, 422, 424. The loops 432 are in fluid communication with the inlet 290′ at a first end, and with a second (inner) pair of U-shaped loops 434 at a junction 436 at a second end. See FIG. 12. The loops 434 are in fluid communication with the loops 432 at a first end, and with a third (innermost) pair of U-shaped loops 438 at a junction 440 at a second end. See FIG. 13. The loops 438 are in fluid communication with the loops 434 at a first end, and with the outlet 294′ at a second end. See FIG. 12.

As stated above, the baffles 420, 422, 424 define not only legs (or sections) of the perimeter flow path(s) 300′, but certain of the loops (e.g., 432) of the serpentine flow path(s) 298′. As also stated above, the baffles 420, 422, 424 are formed or joined as a single U-shaped unit. Disposed inwardly of the baffles 420, 422, 424 are a plurality of U-shaped baffles 442, 444, 446, 448, 450, each of which may include three baffle sections formed or joined as a single unit, like the baffles 420, 422, 424. The plurality of U-shaped baffles 442, 444, 446, 448, 450 define, in part, the pairs of loops 432, 434, 438, in combination with a single baffle 452 disposed inward of the innermost U-shaped baffle 450.

A plurality of lateral baffles 454,456 is disposed at the junctions 436, 440 to define the connections between adjoining pairs of loops 432, 434, 438. In particular, the baffle 454 may be disposed at and adjoining the ends of baffles 442, 444, 446, while the baffle 456 may be disposed at and adjoining the ends of baffles 446, 448, 450. In addition, further walls and/or baffles may be disposed at the second end 208′ of the plate 202′ to cooperate with the baffles 354, 356 to define the turns between adjoining passages in the pairs of passages. Moreover, one or more gated walls with apertures may be disposed at this end to provide structural reinforcement while permitting flow of fluid.

It is believed that the serpentine paths 298′ of the embodiment of FIGS. 12 and 13 may have certain advantages, even with respect to the embodiment of FIGS. 10 and 11. In particular, the pairs of passages in the embodiment of FIGS. 10 and 11 are joined either at the first or the second end of the trough 200′ to the adjacent pair or pairs of passages by relatively sharp, 180-degree turns defined by the subsets of lateral baffles. It is believed that these turns can cause regions where the fluid flow is uneven (e.g., disrupted fluid flow, localized low fluid flow, and/or possibly even recirculation), leading to uneven or decreased heat transfer. By contrast, the loops in the embodiment of FIGS. 12 and 13 provide more gradual changes in the directionality of the fluid, in particular in the region closest to the discharge end. This is believed to result in more even fluid flow, leading to more even (and improved) heat transfer. While there still are 180-degree turns, these turns occur at the junctions 436, 440 adjacent the inlet end (instead of the discharge end) and are more limited in number. Thus, it is presently believed that the embodiment of FIGS. 12 and 13 may provide additional advantages over the embodiment of FIGS. 10 and 11, which itself provides a number of advantages.

In operation, a fluid is circulated through the serpentine flow paths 298′ and a fluid is circulated through the perimeter flow paths 300′. One type of fluid (e.g. water) may be used for both flow paths, or different types of fluids may be used in the paths 298′, 300′. In a similar way, the same equipment may be used to move the fluid through both paths 298′, 300′, or different equipment (e.g., pumps, filters, tanks, and the like) may be used for the paths 298′ as opposed to the paths 300′. Separate equipment may allow for variations in the flow rates, for example, between the paths 298′ and the paths 300′.

While the troughs 200, 200′ illustrated herein include baffles, it is not a requirement of the disclosure that baffles be included in all embodiments of the trough 200, 200′. Instead, it is believed that the flow paths defined by the baffles may further improve the fluid flow and heat transfer characteristics of the trough 200, 200′, but certain advantages are obtained by the structure and method of fabrication of the trough 200, 200′ discussed above separate and apart from this additional improvement.

It is further believed that the use of a perimeter flow path in the channel between the plates may have advantages even when the spacers described and illustrated are not as in the embodiments of FIGS. 2-8 (and FIGS. 10 and 11). That is, it is believed that the inclusion of at least one perimeter flow path with the at least one serpentine flow path may have advantages when used with a trough as illustrated in FIG. 1, with planar or flat walls joining the arcuate plates. Still, by including both flow paths between the plates, it is believed that the overall structural integrity of the trough 200′ may be maintained. At the same time, as noted above, the flow paths 298, 300 may be operated separately from each other, permitting the flow in the perimeter to be optimized for the localized heat loads along the edge of the trough and simultaneously the flow in the center to be optimized for the heat load transferred over the larger surface area in heat transfer with the serpentine paths.

Although the preceding text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, which is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

What is claimed is:

1. A feed trough for an electric arc furnace, comprising:
a first arcuate plate and a second arcuate plate,
each arcuate plate having opposing first and second end edges and opposing first and second side edges, the first and second end edges comprising an arcuate contour and a junction between the first end edge and each of the first and second side edges comprising an arcuate contour;
at least one first spacer attached to the first end edge of the first plate and the first end edge of the second plate,
the first spacer having an arcuate cross-section and an arcuate contour;
at least one second spacer attached to the junction between the first side edge and the first end edge of the first plate and the junction between the first side edge and the first end edge of the second plate, and
at least one third spacer attached to the junction between the second side edge and the first end edge of the first plate and the junction between the second side edge and the first end edge of the second plate,
the second spacer and the third spacer each having an arcuate cross-section and an arcuate contour; and
at least one fourth spacer attached to the first side edge of the first plate to the first side edge of the second plate, and
at least one fifth spacer attached to the second side edge of the first plate and the second side edge of the second plate,
the fourth spacer and the fifth spacer having an arcuate cross-section,
wherein the first and second arcuate plates have a channel disposed between inner surfaces of the first and second arcuate plates, and further comprising at least one serpentine flow path and at least one perimeter flow path, the at least one serpentine flow path disposed toward a midline of the trough and the at least one perimeter flow path disposed outwardly of the at least one serpentine flow path.

2. The feed trough according to claim 1, wherein the at least one perimeter flow path is disposed generally adjacent to the spacers.

3. The feed trough according to claim 2, wherein the at least one perimeter flow path comprises a first leg adjacent the fourth spacer, a second leg adjacent the first, second and third spacers, and a third leg adjacent the fifth spacer, each of the legs having at least one passage.

4. The feed trough according to claim 2, wherein the at least one perimeter flow path comprises a first leg adjacent the fourth spacer, a second leg adjacent the first, second and third spacers, and a third leg adjacent the fifth spacer, each of the legs having two parallel passages.

5. The feed trough according to claim 1, wherein the at least one serpentine flow path comprises a plurality of concentric or nested U-shaped passages or loops, with an outermost loop in fluid communication with an inlet and an innermost loop in fluid communication with an outlet, the outermost loop adjacent the at least one perimeter flow path.

6. The feed trough according to claim 5, wherein the plurality of nested loops are disposed in pairs of loops, each pair of loops in fluid communication with a next pair of loops.

7. The feed trough according to claim 1, wherein the at least one serpentine flow path comprises a series of successive passages disposed in a back-and-forth pattern between an inlet and an outlet.

8. The feed trough according to claim 7, wherein the series of successive passages are disposed in pairs of passages, each pair of passages in fluid communication with a next pair of passages and the fluid in each pair of passages flowing in an opposite direction than the next pair of passages.

9. A feed trough for an electric arc furnace, comprising:
a first arcuate plate and a second arcuate plate,
each arcuate plate having opposing first and second end edges and opposing first and second side edges,
the first and second end edges comprising an arcuate contour, and the first and second end edges of the first and second arcuate plates attached and first and second side edges of the first and second arcuate plates attached,
a channel disposed between the first and second end edges, first and second side edges, and inner surfaces of the first and second arcuate plates,
the channel comprising at least one serpentine flow path and at least one perimeter flow path, the at least one serpentine flow path disposed toward a midline of the feed trough and the at least one perimeter flow path disposed outwardly of the at least one serpentine flow path.

10. The feed trough according to claim 9, wherein the at least one perimeter flow path is disposed generally adjacent to at least one of the first and second end edges and to the first and second side edges.

11. The feed trough according to claim 10, wherein the at least one perimeter flow path comprises a first leg adjacent the first side edge, a second leg adjacent the at least one of the first and second end edges, and a third leg adjacent the second side edge, each of the legs having at least one passage.

12. The feed trough according to claim 10, wherein the at least one perimeter flow path comprises a first leg adjacent the first side edge, a second leg adjacent the at least one of the first and second end edges, and a third leg adjacent the second side edge, each of the legs having two parallel passages.

13. The feed trough according to claim 9, wherein the at least one serpentine flow path comprises a plurality of concentric or nested U-shaped passages or loops, with an outermost loop in fluid communication with an inlet and an innermost loop in fluid communication with an outlet, the outermost loop adjacent the at least one perimeter flow path.

14. The feed trough according to claim 13, wherein the plurality of nested loops are disposed in pairs of loops, each pair of loops in fluid communication with a next pair of loops.

15. The feed trough according to claim 9, wherein the at least one serpentine flow path comprises a series of successive passages disposed in a back-and-forth pattern between an inlet and an outlet.

16. The feed trough according to claim 15, wherein the series of successive passages are disposed in pairs of passages, each pair of passages in fluid communication with a next pair of passages and the fluid in each pair of passages flowing in an opposite direction than the next pair of passages.

17. A feed trough for an electric arc furnace, comprising:
a first arcuate plate and a second arcuate plate,
each arcuate plate having opposing first and second end edges and opposing first and second side edges, the first and second end edges comprising an arcuate contour and a junction between the first end edge and each of the first and second side edges comprising an arcuate contour;
at least one first spacer attached to the first end edge of the first plate and the first end edge of the second plate,
the first spacer having an arcuate cross-section and an arcuate contour;
at least one second spacer attached to the junction between the first side edge and the first end edge of the first plate and the junction between the first side edge and the first end edge of the second plate, and
at least one third spacer attached to the junction between the second side edge and the first end edge of the first plate and the junction between the second side edge and the first end edge of the second plate,
the second spacer and the third spacer each having an arcuate cross-section and an arcuate contour; and
at least one fourth spacer attached to the first side edge of the first plate to the first side edge of the second plate, and
at least one fifth spacer attached to the second side edge of the first plate and the second side edge of the second plate,
the fourth spacer and the fifth spacer having an arcuate cross-section.

18. The feed trough according to claim 17, wherein each of the at least one first spacer, the at least one second spacer, the at least one third spacer, the at least one fourth spacer, and the at least one fifth spacer is cast.

19. The feed trough according to claim 17, wherein each of the at least one first spacer, the at least one second spacer, the at least one third spacer, the at least one fourth spacer, and the at least one fifth spacer is welded to the first and second arcuate plates.

20. The feed trough according to claim 17, the first and second arcuate plates having a channel disposed between inner surfaces of the first and second arcuate plates, and further comprising a plurality of baffles disposed in the channel, the plurality of baffles defining at least one serpentine flow path.
